(19) United States
(12) Patent Application Publication
(10) Pub. No.: US 2006/0206363 A1
(43) Pub. Date: Sep. 14, 2006

(54) Group travel planning, optimization, synchronization and coordination software tool and processes for travel arrangements for transportation and lodging for multiple people from multiple geographic locations, domestic and global, to a single destination or series of destinations

(76) Inventor: Jeremy James Gove, San Francisco, CA (US)

Correspondence Address: Jeremy Gove, 994 De Haro St., San Francisco, CA, 94107, US

(21) Appl. No.: 11/374,451

(22) Filed: Mar. 13, 2006

Related U.S. Application Data
(60) Provisional application No. 60/594,122, filed on Mar. 13, 2005.

(51) Int. Cl. G01C 21/34

(52) U.S. Cl. 705/6

(57) ABSTRACT

The present application is built around a software tool that optimizes group travel versus today's solutions. The present invention enables a user to search, optimize, synchronize, coordinate and book travel for Lodging and Transportation for multiple people from multiple locations around the country/globe to a single destination or series of destinations. The search and planning software tool allows one user to plan and query a group trip in one click which returns a summarized group trip itinerary along with each group members individual itinerary. The high level optimization engine can be used to select destinations, dates of travel, lodging, transportation modes representing air, bus, train, automotive travel and routes for each based on group member locations, “True Time of Travel” relative to value of time, and optimization preferences such as lowest total cost of the trip, “maximize the amount of time group members spend together at group budget”, or shortest total travel time. The synchronization engine works with data at the lower level of detail and optimizes individual itineraries subject to individual and group trip constraints such as “Each member must arrive within a two hour window.” The coordination engine allows the trip for all members to be coordinated in one place with the ability to hold reservation, auto/systemic confirmation of each individual, book reservation, choose costing methods, negotiate changes, and communicate with trip members. This software tool reduces the time/stress involved in planning/coordinating group trips, reduce environment costs, reduce financial costs, and simplify the current coordination process.

### CROSS REFERENCE TO RELATED APPLICATIONS

The present application claims priority from U.S. Provisional Patent Application Ser. No. 60/594,122, entitled “Group Travel Planning, Optimization, Synchronization, and Coordination Tool and Processes for travel arrangements (Transportation and Lodging) for multiple people from multiple geographic locations (Domestic and Global) to a single destination or series of destinations”, filed on Mar. 13, 2005.

### FEDERALLY SPONSORED RESEARCH

Not Applicable

### SEQUENCE LISTING OR PROGRAM

Not Applicable

### TECHNICAL FIELD OF THE INVENTION

The present invention relates generally to online travel websites. More specifically the present invention relates to an online website and enabling software as means for group travel planning, optimization, synchronization and coordination for multiple people from multiple geographic Locations to a single destination or series of destinations.

### BACKGROUND OF THE INVENTION

Today's online travel sites allow a user to search/book travel arrangements for transportation and lodging for one or more persons from one originating point to another point. Today's software tools are optimized for single point to single point travel. However, due to many environmental factors such as scattered workforce, scattered families/friends, outsourcing, global business, etc., optimizing group travel from many points to a single point is a significant need and not easily accomplished using today's applications. The present application is built around a software tool that optimizes group travel versus today's solutions. This software tool will have several high level impacts. It will reduce the time consumed in planning/coordinating group trips, reduce environment costs (pollution/fuel/energy), reduce financial costs, and simplify the current process.

U.S. Pat. No. 5,237,499 is focused on groups; however, it is focused on applying discounts and giving information to people who are part of the group. Travel is researched, planned, and booked individually and is not in the scope of the patent.

U.S. Pat. No. 5,948,040 is focused on creating a comprehensive solution of information and booking capabilities. It is focused on individual travel from the same location. It has a focus on multi-stop vacations to destinations not serviced by air and looks at alternative forms of transportation to those destinations. The user must know the end destination and use this system to stop along the way. This patent also claims to provide all inclusive data with multimedia information to help users select a location destination based on their individual wants/desires for a trip by creating a software tool to research destinations and learn about them. It does not select a destination for the user based on optimization of group members' locations and a collection of general group preferences such as Activities, temperature, Beach/Warmth, and Skiing.

U.S. Pat. No. 6,324,517 is focused on finding the lowest total cost facility for having a conference or meeting. (Including Meals, Facility, Hotel, Flight). It does not book travel or the facility, it simply rankings different conference/meeting sites to aid in selecting a facility.

U.S. Pat. No. 6,477,520 is focused on optimizing individual travel based on the true cost (Cost, loss in productivity (Based on salary), Preferences, Negotiated corporate discounts). This software tool is focused on individual travel versus group and calculations are based on salary and do not include all of the time components.

### SUMMARY OF THE INVENTION

The present invention enables a user to search and book travel for multiple people from multiple locations around the country/globe to a single destination or series of destinations. The end travel destination does not have to be known. The software tool would select the end travel location in an optimized fashion based on group or coordinator preferences such as total group costs or total flight time or other consolidated preferences.

Additionally, the time/date could also be optimized based on the preferences, optimization choice and calendar availability of each member of the group. The final optimization piece is moving from a single mode transportation model currently used in the prior art to a multi-mode transportation model including but not limited to Flight, Bus, Train, Auto, and Boat. Meaning that all nodes of transportation are taken into consideration when optimizing travel plans. The software tool then allows the trip for all members to be coordinated in one place such as hold reservations, auto/systemic confirmation of each individual, and book reservation.

This software tool is applicable to all major segments that have a need to travel such as consumer, business, government, agents, military, education, non-profits, etc. The basic principles could be used to schedule/plan face-to-face meetings within a city setting. It could be used to select consolidation points within the transpiration industry such as Shipping or trucking. It's event applications span small friends/family trips to wedding planning to retreats to major conferences.

The present invention utilizes a web-based interface to interact with a consumer, government, or corporate customers. Profiles are established for each member that is a part of the trip, although, this is not a requirement. Data sources from the travel industry are used for two purposes; first to fuel the optimization/synchronization engines; and second to reserve/book the travel. For the optimization engine to work, the world is broken out into nodes. The connection from one node to another, and the direction of travel constitutes a unique combination (Key) in an internal database. For each key, a record set is created that coincides with the preferences and travel information is used for optimization.

One example is cost optimization on flights. For each key, the cheapest flight information for that key will be saved in the record with associated periods. Note, that as computing capacity increases over time, these associations based on the key are queried using live data versus static data. Delta loads from various industry sources are then used to maintain these high level combinations with the latest data. The initial optimization engine runs from this semi-optimized table of preferences and the user input such as Number of people, and location of people. Top recommendations are moved to the next optimization and synchronization engine, which adds real-time data to the recommendations to arrive at actual detailed information versus high level estimated information. The output from this engine is then displayed to the consumer who may then begin to coordinate, book and pay for the trip all in the one system.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating an overview of the system of the present invention;

FIG. 2 is a flow chart illustrating the user flow of group trip research and trip selection;

FIG. 3 is a flow chart illustrating the user flow of booking and the coordination engine of the present invention;

FIG. 4 is a flow chart illustrating the user flow when responding to a planned group trip of the present invention;

FIG. 5 is a flow chart illustrating user flow of profiles;

FIG. 6 is a flow chart illustrating the synchronization engine of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The present invention enables a user to search and book travel for multiple people from multiple locations around the country/globe to a single destination or series of destinations. The end travel destination does not have to be known. The software tool could select the end travel location in an optimized fashion based on group or coordinator preferences such as total group costs or total flight time or other consolidated preferences.

Additionally, the time/date could also be optimized based on the preferences, optimization choice and calendar availability of each member of the group. The final optimization piece is moving from a single mode transportation model currently used in the prior art to a multi-mode transportation model including but not limited to Flight, Bus, Train, Auto, and Boat. Meaning that all nodes of transportation are taken into consideration when optimizing travel plans and multiple modes can be used for one trip. The software tool then allows the trip for all members to be coordinated in one place such as hold reservations, auto/systemic confirmation of each individual, and book reservation.

This software tool is applicable to all major segments that have a need to travel such as consumer, business, government, agents, military, education, non-profits, etc. The basic principles could be used to schedule/plan face-to-face meetings within a city setting. It could be used to select consolidation points within the transpiration industry such as Shipping or trucking. It's event applications span small friends/family trips to wedding planning to retreats to major conferences.

The present invention utilizes a web-based interface to interact with a consumer, government, or corporate customers. Profiles are established for each member that is a part of the trip, although, this is not a requirement. Data sources from the travel industry are used for two purposes; first to fuel the optimization/synchronization engines; and second to reserve/book the travel. For the optimization engine to work, the world is broken out into nodes. The connection from one node to another, and the direction of travel constitutes a unique combination (Key) in an internal database. For each key, a record set is created that coincides with the preferences used for optimization.

Coordinating & Booking Engine/Web Interface Software Toolset

Plan/book/cost travel for multiple people from multiple locations to a single location all in one screen/query. A trip can be planned and coordinated all in one place. Group profiles and availability can be taken into account immediately. The coordinator can set up the trip, the system can book the trip immediately, or, it can hold the reservation until the members (All, %, key personnel) have committed directly to the system via email, phone or instant message.

This component saves time in coordinating the trip. Rather than running 20 queries repeatedly and adding up costs and coordinating schedules, a user can do it all in one click. Rather than following up with everyone individually on each option, the system can follow up with everyone automatically and allow each member (optional) to make/suggest changes and follow a systematized reiterative process to agree on the group trip.

This component saves money. Rather than each individual optimizing their particular element of the trip from a cost perspective, the group as a whole can be optimized to bring down total cost.

This component encourages groups such as families, friends, business associates, wedding parties, etc. to travel together and reduces stress by simplifying the process. Coordinating a trip for many people can be a extremely difficult thing to accomplish, especially as user numbers grow. This can scare people away from planning group travel. This software tool simplifies the process and enhances communication via group/project software tools and common status screens.

Coordinated Group Payment. If a company would like to plan a trip and keep their customer costs down to $300 for example, they could specify this criteria and the customer will only see $300 when they are booking their reservation through the system regardless of the price. The company picks up the differences. Likewise, family/friends trips could use this spread total trip costs via ability to pay or split entire group costs equally, independent of how much each individuals travel costs were (Example: Differing costs due to differing origination points).

Optimization Engine

Optimize group travel from different origination points to a single destination or series of destinations based on criteria such as total group cost or total travel time or by an effort to maximize the consolidated group preferences. Optimize destination, dates, transportation mode/route, individual, trip or group preferences or combinations thereof based on optimization criteria such as lowest total cost trip or maximize total time of trip with group members or shortest travel time etc.

Destination, Lodging, Time, group Optimization Benefits

This component can save time and be used for research/simulation. This component can be used to decide where the best place to hold a family reunion, wedding, retreat, sales meeting, etc., based on the location of potential participants/guests, preferences, and optimization criteria.

This component saves money. It can select the best location that meets user preferences and has the lowest group travel cost. It optimizes based on the sum of each individuals trip costs versus today's models that optimize each individual's travel plans independently and then add up the costs.

Conversion of tacit knowledge into systemic implicit knowledge that can be leveraged across customer bases when planning/researching/booking travel. Rather than rely on manual methods to plan travel, this model systematizes knowledge that can be shared across the entire customer base.

Conservation of Fuel

By selecting optimal solutions for group travel, fuel consumption and pollution could be reduced on a micro level.

Multi-Mode/Route Selection Travel Benefits

Rather than having to go to one system to check flights, another to check trains, etc., the system will consolidate all modes of transportation into the planning/booking engines. This component saves time. Rather than having to go to one system to check Airline prices, another to check Train prices, another to check bus prices, this system incorporates all modes of transportation into one system.

This component saves money. As all modes of transportation are considered, a user can select the mode of transportation. A user could also look at using multiple modes of transportation to get from point A to point B rather than a single mode.

This component increases competition across various transportation modes. In certain markets, this could create larger competition between train—air prices or between bus—air prices, which could bring overall transpiration costs down. This component can also be used to optimize on preferences to make the best decision for travel from an environmental perspective.

Door-to-Door Travel Time Benefits

Time components built into system (To account for driving to nearest mode, airline queues, etc.). To account for the different times associated with different transportation modes, additional times will be built into the optimization algorithms. In addition, different modes can be selected in the optimization engine depending on a user's value of time. This also includes travel time to nearest mode. This can then be used to optimize on true time of travel (“Door to Door” travel time) when used in conjunction with other components such as mode selection relative to a users value of time.

This component is focused on saving and valuing time. In a corporate setting for example, the value of individual times (Based on salary) could be built into the optimization engine to pick a location that saves the company money from a productivity standpoint. Or, it could be used to justify paying for other business partners to travel to a user, even though traditional thinking may say they should pay for the trip if they fly to a user and vise versus. It could also be used for consumers to make decisions between mode of travel.

This component increases well-being. From a user location, the bus might be the best way to travel when taking into account traveling to the airport, parking, getting ticket, queuing in security, and waiting at the gate, getting luggage on the other end, etc. This component will hopefully allow people to make better decisions for their travel as well as increase alternative transportation methods.

Functionally, this component has a set of tables with industry averages and overrides for specific routes that deviate significantly from the average for information such as queue times. Secondly, this component calculates the travel time to nearest set of nodes for the points of origination and destination based on various data sources and the parameters passed to it from the trip profile. This information is then passed to the optimization engine which will use this information as one component when determining which of node/mode combination (Or set of) should be chosen based on preferences and total door-to-door travel time. The information is also passed to the group and individual trip profiles to show total travel time of selected itinerary.

Synchronization Engines

The synchronization engines refine individual trip itineraries at the detailed level subject to the constraints of the trip profile/group trip parameters. A constraint example would include the arrival window for all trip members to arrive. For example, a constraint could be used to ensure all participants arrive within 30 minutes regardless of cost. The primary benefits include: savings on travel costs from node to destination; time savings for members waiting/picking up others; maximization of time that group members spend together; tradeoffs understood and managed in simple format; and the ability to create alternatives when group criteria can not be met

Travel Planning, Research and Simulation

This component allows the user to plan a group trip consisting of individual itineraries in one place and with minimal effort versus the effort required to do so with today's software tools. The primary benefits include: financial savings due to consolidated optimization of group trip versus individual optimization of individual itineraries independently; time savings in researching and planning trips; better planned trips leading to higher levels of satisfaction; and improved decision making.

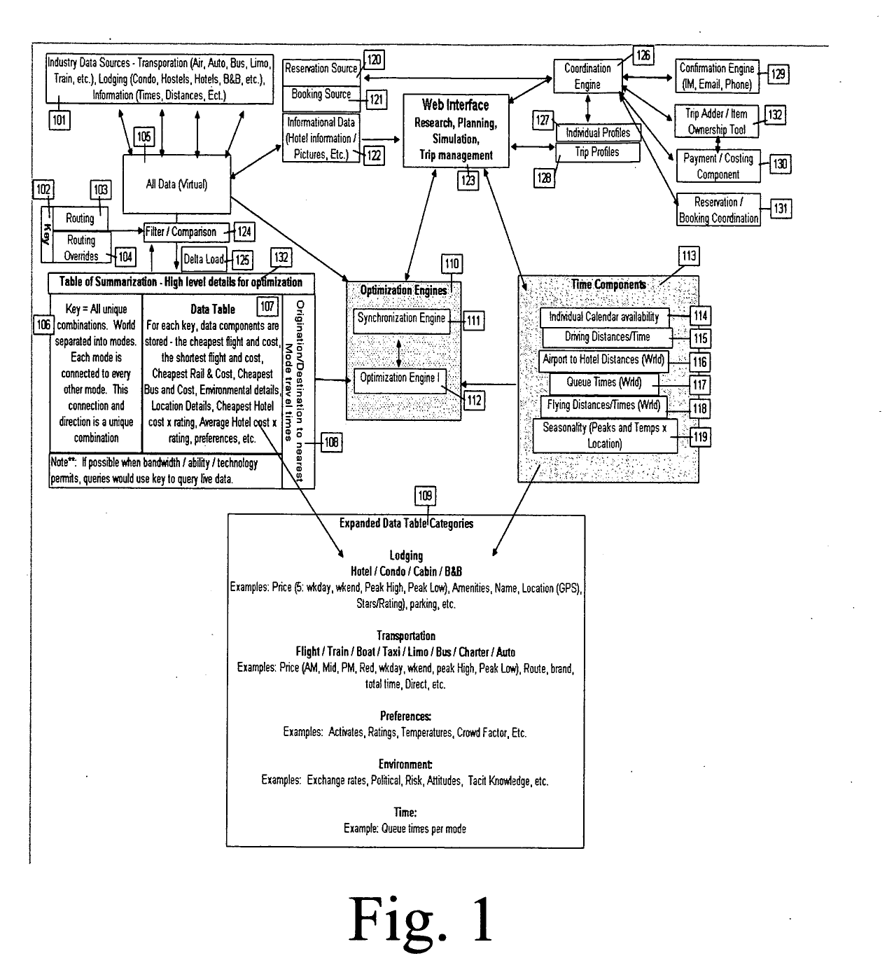

Now referring to FIG. 1 the high-level system architecture necessary to accomplish the process and optimization goals outlined are illustrated. The starting point is the table of summarization (132). The table of summarization is used to create summarized data at a high level of detail that can be queried quickly to optimize complex many-to-many optimization problems. All geographic locations are broken out into nodes. All unique combinations of node-to-node travel and direction are stored as keys in the table (106 & 102). For each key, the table stores travel information such as the lowest flight cost or the shortest flight time, cheapest rail, travel preferences, multimode alternatives, hotel costs by rating, political risk, activities, other preferences, environment, weather profile, etc (107). This data is continually refreshed with changes to actual data (101) via interfaces (105) by referencing Delta loads versus refresh (125). It would be obvious to one of ordinary skill in the art to that this static model would switch to a live model as technology permits.

The two routing tables, Routing (103) and Routing Exceptions (104), are used to populate the table of summarization. For each key, there are multiple possible routes associated including multi-mode options. This could mean flying ¾^{ths} of the way and driving, taking a train, or taking a Bus for the final ¼^{th} of the trip. For example, if a group was planning to go to Vail, they could fly into Vail Airport, Denver Airport, Grand junction Airport, Aspen, etc. Each possible route is checked to find the best solution for each preference type (Such as cheapest cost or shortest time). The best solution for each preference type is then passed to the table of summarization if the result is different than what is already stored (124) for use in optimization.

In the static model, prior to real-time optimization off of live data, each routing component will have five data points captured. 1). The cheapest price 2). The shortest time traveled, 3). The midpoint 4). The point at which costs begin to skyrocket for each additional time component saved (Or point at which incremental time savings becomes small relative to cost increase) and 5). The point at which cost savings are marginal relative to the increase in travel time. The two ends of the spectrum on the cost relative time continuum is going to be shortest time (high cost option) and cheapest travel (high time option). The initial five data points in the table of summarization will allow the tradeoff to be optimized quickly.

When a user enters information into the web interface (123), trip profiles (128), personal profiles (127), preferences (109), synchronization and optimization (110) criteria are fed to the optimization engine I (111) which creates a filter, query and or linear program to pull the results from the table of summarization to develop potential itineraries. The optimization engine can optimize the destination of the trip, the dates of the trip, mode/route of individuals on trip, and lodging based on trip preferences and member locations. The optimization also considers various time components (113) such as destination/origin time to nearest mode (108), electronic calendar availability (114), driving times (115), hotel locations (116), queue times (117), flight times (118), or seasonality (119) considerations.

This engine than feeds the results to the synchronization engine (112) which follows a reiterative process to create each individual itineraries constrained by each group itinerary, trip and individual preferences. The synchronization engine takes the high level summarized results and retrieves actual live data from the various data sources, performs a final synchronization/optimization operations on detailed preference information, such as ensuring that all members arrive within a 2 hour window, value of time preferences, or individual budget information for example, and either sends information back to optimization engine I for further results or provides the actual optimized itineraries back to the web interface. The tool manages the synchronization cost versus time tradeoffs by using a default value of time or a user entered value of time. The tool will also assign hotel roommate assignments and auto rental sharing assignments based on preferences and arrival/departure times. For each individual and group itinerary, alternatives will be returned for the group trip and ranked according to the group and individual preferences. The top solutions (with exceptions & alternatives) are returned to the user (summary and details) for acceptance or modification.

From here, the user can view supplemental information such as hotel site information (122), continue the research and simulation or they may begin coordinating the trip (126). The user may add additional items to the trip (132) such as ski tickets, group food for the trip or concert tickets. An owner is assigned for each item and these items will be billed to the trip members along with their travel arrangements. The owner of each item then receives a credit for the amount to go and purchase the items for the group. The coordinating engine would then confirm the trip (129) with the various participants and then book the trip (121) or hold a reservation (120) through the booking engine (131). Various group payment options are available through the payment engine (130) such as equal payments, ability to pay, or pay own direct costs.

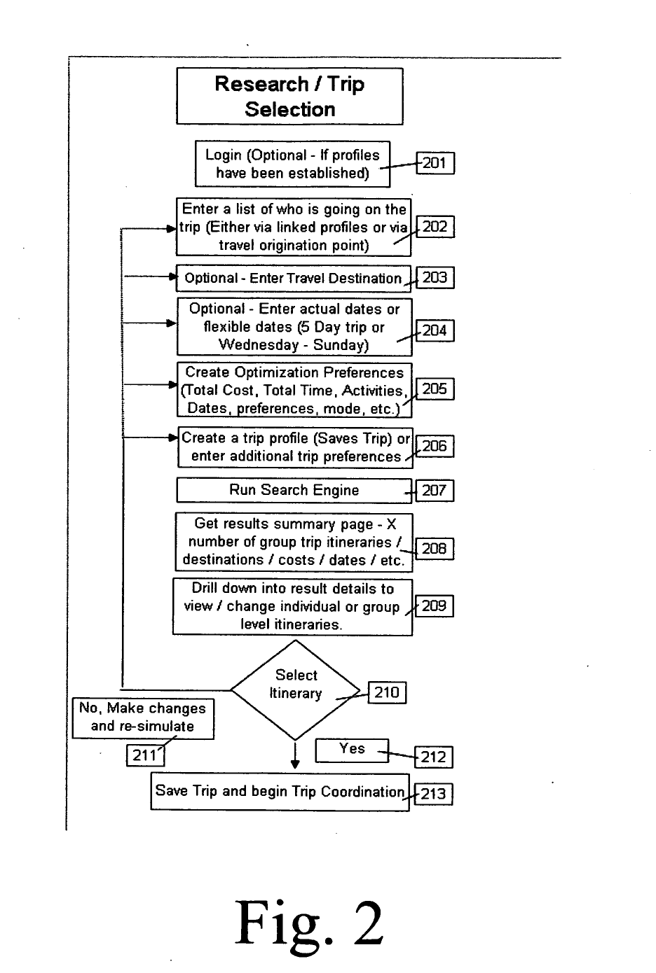

Now referring to FIG. 2, the user experience from a high-level when researching possible trip itineraries, costs, or other options is illustrated. A user interacts with the software tool via a web-based interface (201). They may log-in to the system, set up a profile, or begin using the tool directly. The basal criteria that a user must enter includes the group members (202) for the trip or the locations of each member, if profiles are not linked, basic trip preferences such as destination (203) (or allow system to optimize the destination based on trip optimization preferences), and dates or general periods of time (204). Additional information may be provided to further refine the results via the optimization preferences such as limiting results by the cost or budget that individuals or the group is willing to spend (205), Cheapest total trip costs, shortest travel time for group as a whole, modes of transportation, maximize the length of trip based on cost willing to spend, or maximize group preferences (such as activities, weather, hotel star ranking, etc). The synchronization preferences can be made at the group level (All members must arrive within 2 hours of each other), or at the individual level (Hotel preferences, Auto Preferences, extra days for certain members, amount of time willing to commit for trip, etc.).

After setting the trip parameters, with one click of the mouse, the engine then runs (207) and returns a summarized view (208) of possible group itineraries with the capability to drill down (209) to view each individual itinerary details. Changes at the group level itinerary or individual level itineraries can be made in the drill down or later in the coordination engine. This is an iterative process (210) that can be run many times (211) in a simulation/“What if” format. Once a desired itinerary is selected (212), the information is passed to the coordination/booking engine (213). The user may save the trip parameters at any time as a trip profile and may also send a pre-trip profile to the group to solicit their feedback for the proposed trip.

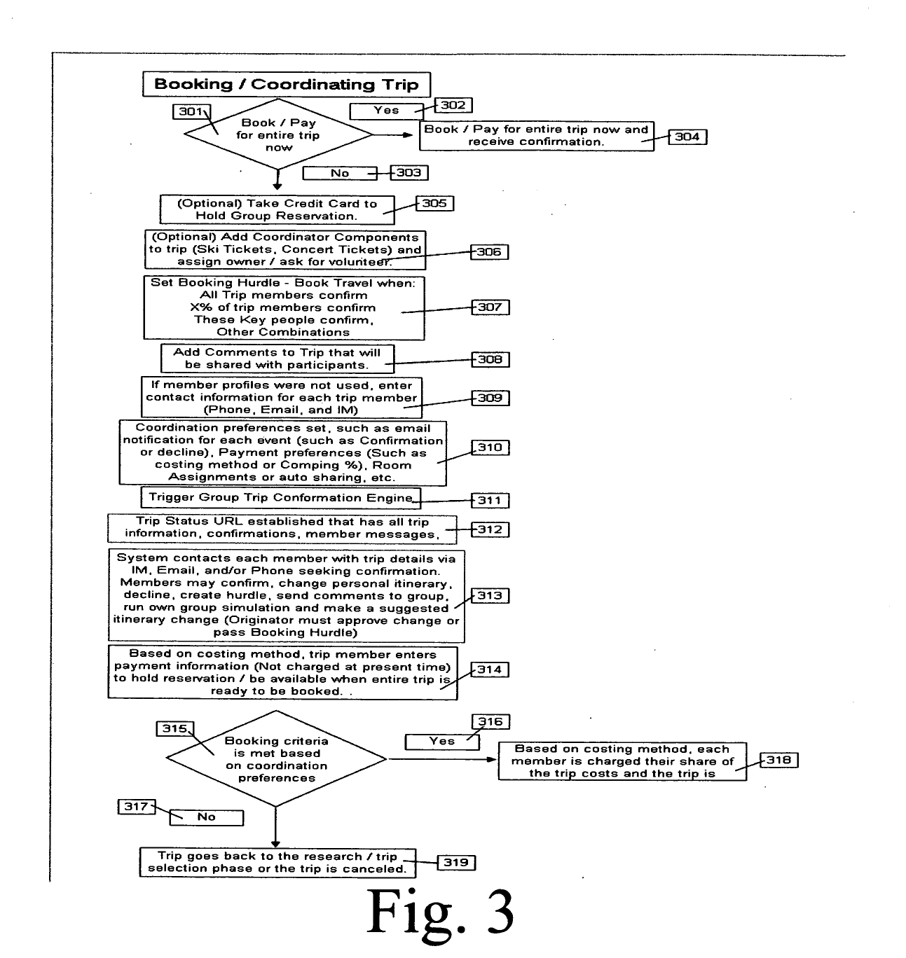

FIG. 3 illustrates the coordination/booking engine of the present invention from the user perspective. This software component accomplished four level consolidated tasks, trip profile management, holding reservations/booking/payment engine, trip confirmation/trip negotiation tool, and a group project management type tool.

Trip Profile Management

Additional information may be added to the trip profile depending on whether or not all group members profiles are linked (300). If the coordinator plans to book/pay (301) for the entire group trip immediately (302) the coordinator would then have to fill in the additional details for each traveler such as full name (If needed) and contact information prior to booking the travel arrangements (304). When each or some members must confirm their element of the trip, the coordinator must enter contact information for each member if their profiles are not linked via a “Friend” status (Which has name/contact information imbedded).

Other preferences for the trip profile must be set (303). For example, the costing method must be determined (Everyone pays for their own direct costs, everyone pays equally, everyone pays according to ability to pay, etc.) or any “comping” of the trip applied (309). Booking hurdles must be set if the trip requires confirmation (307). For example, if all members must commit before the trip for each member's trip is converted from a reservation to a booking, or if say 10% must commit or if key people must commit. If the 10% or key people option is selected, the only element of the trip that will be booked once it has passed the hurdle, only those members' trips who have confirmed will be booked.

Initial payment information (305) must be added in the trip profile by the coordinator at this time to hold the reservation until the trip has passed the booking criteria to be booked. As each member confirms, they will be asked to add their payment information.

Holding Reservations/Booking/Payment Engine

This element of the software tool allows the group reservation to be held until the trip has reached its booking criteria (314). Booking options or criteria includes percentage of members confirm trip, key members confirm trip, all members confirm trip, book all travel now, book individual components now as members confirm, etc.. As each member confirms, their payment information is stored and their element of the reservation is transferred to their name. This gives group members, who are separated by geography, time to confirm the trip prior to anyone committing money to the group trip. Once the booking criteria is reached (315), the trip is booked (317) based on the costing method used. Depending on the costing method used (313), the trip may not book until all/specific members have confirmed. When the trip is booked, payment is taken.

The payment engine covers four primary cost components, travel arrangements (transportation, hotel, etc.), trip adders (Such as ski tickets or group food allowances), service fees (For using service), and coordinator added fees (Trip coordinator could take on a fee). The group trips costs (Travel arrangements, adders, service fees, & coordinator added fees) can be spread across group members in a variety of ways in the payment engine. This software tool allows the group to spread costs by: 1) Everyone pays equal share of total group trip (transportation, lodging, rental, etc.) 2) Ability to pay (Based on private estimate or behind the scenes profile information) 3). Comping (Percentage, Fixed Dollar Value regardless of cost, comping party picks up costs above a fixed cost amount) 4). Everyone pays for their individual costs 5). Everyone to pay equal share based on cheapest transportation to location and shared costs (Hotel, Auto, Transportation, Etc.) on initially planned trip. Cost increases (Or decreases) due to changes made at the individual itineraries level are passed along to the individual rather than spread across the group 6). “Donation”—Individual member pays more and assigns it to other member and 7). Other variations. These preferences are set both at the high level coordination level but can also be changed at the individual level when confirming a trip. In addition, the originator of the trip can make the costing blind to all users. In other words, a group member could only see the end result of what they owe for payment versus the actual costs.

Confirmation Component/Negotiation of Trip Members

The element (310) of the software tool sends emails, Instant messages, or phone calls (312) to each member of the trip with trip details, links, and a trip message (308) from coordinator (311). Once the user is contacted, the user has the primary options to confirm reservation (add payment information), make changes personal reservation (add payment Information), wait, set personal conditions, or decline. In addition, members can make changes, research, simulate the trip, by jumping to the research/trip selection software tool, and make a “Counter proposal” to the group and seek confirmation. When the trip has achieved its booking hurdle, the trip will move to the booking engine to be booked. If a trip does not reach the booking hurdle (316), the trip status will go back to the research phase (318)

In addition, this process can occur prior to researching the trip by sending the Pre-Trip Profile out to each member to add their preferences/input/willingness to pay, etc. This information would then be fed into the optimization engine when researching travel. Group “Project” Management/Trip Management Software Tool

This element of the software tool allows the group members to work out the details of the trip via group communication software tools. A primary component is the ability to define and add trip “adders” such as ski tickets, food for the group, or concert tickets for example. The items will be added to everyone's travel expenses and an owner of the item will be assigned or asked to volunteer. They will receive the funds from other group travelers as they book their travel. The owner will then be able to thus purchase the group tickets or food for example. These items may be voluntary with quantities changed or deleted by each group member or they may be mandatory charges.

A current status page is created for the trip where each member can see the group trip details, individual itineraries, who has confirmed and who has not confirmed and who has not been contacted yet. Group members can change room or auto sharing assignments. This space also uses group software tools such as stored group distribution messages that are sent to each trip member and stored on this page so all can see/review or uploaded files. A user can link directly to all of the software tools functionality via the informational screens. The idea is to consolidate all trip related information in the one place that all group members are visiting anyway to confirm their travel.

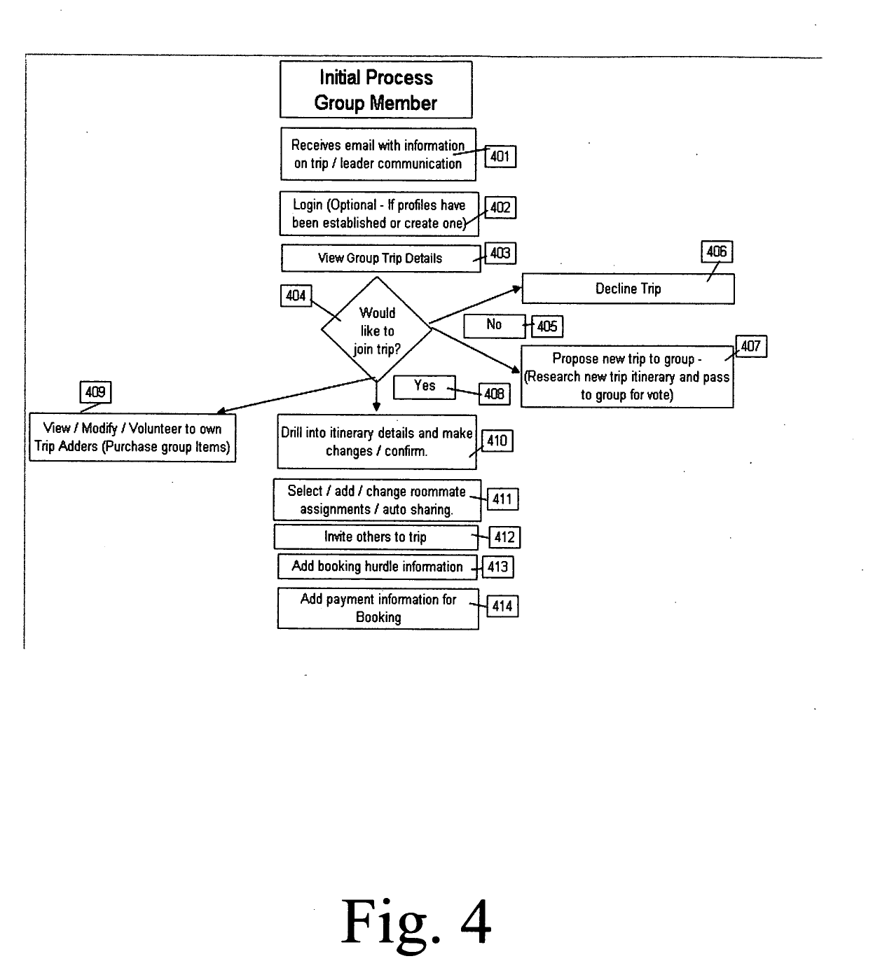

Referring now to FIG. 4, the user experience in the trip management component from a high-level when responding to a planned group trip is illustrated. After a user has received an email (401), they may login (402) to the system, set up a profile, or simply move foreword into the group trip details (403). If they do not like the proposed trip (405), they may either decline (406) or research and propose a new trip to the group (407) which will be voted on by the group or decided by the trip originator. If they do plan to join the trip, they may drill into their trip itineraries (410) to make changes and also see the itineraries of others plotted out on a timeline to coordinate their travel. The user may also change or add roommate assignments (411) or auto sharing. Before entering payment information (414), the user may invite others to the trip (412), add personal booking hurdles, and modify group item or trip “adders” (409) quantities, volunteer as an owner, or decline to participate in event (Ski tickets for example). If the group and individual booking hurdles have already been met, the booking and payment will occur then, otherwise, it will wait until the hurdles have been met.

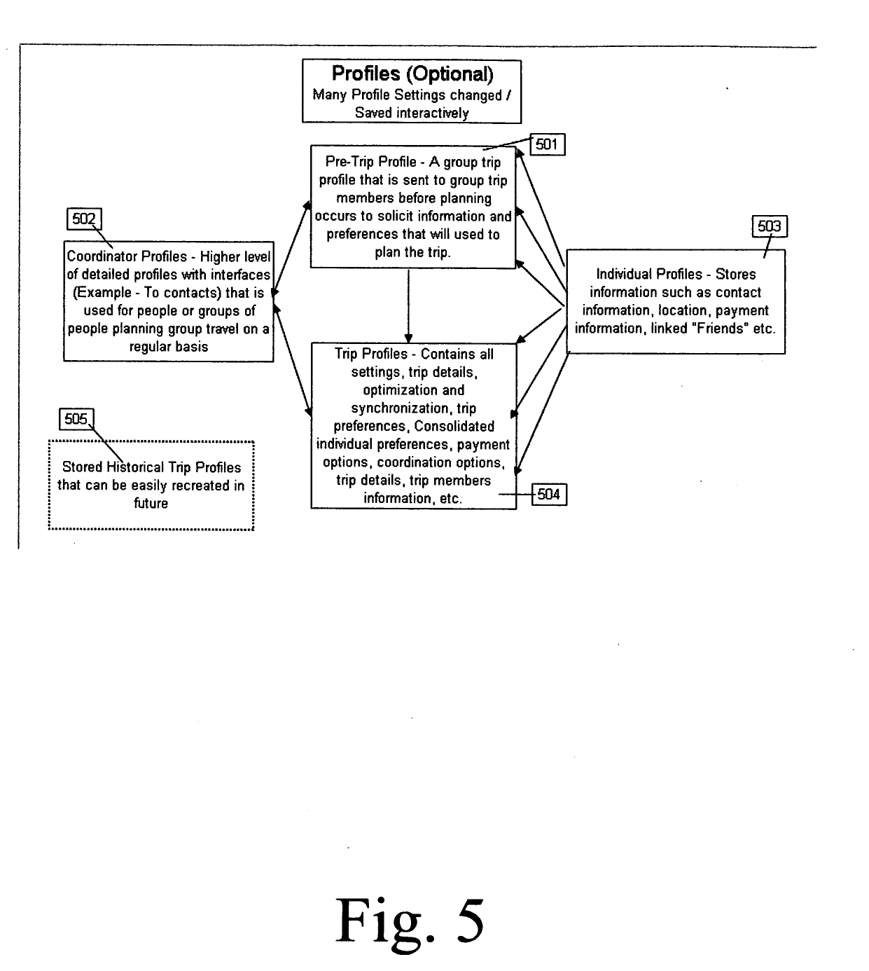

Referring now to FIG. 5, the various types of profiles that can be established are illustrated. There are four types of profiles that can be stored in this software tool to help in the trip planning, optimization, synchronization, and coordination operations. All profiles are optional and only serve as a software tool to reduce manual repetitious data entry. However, the system will create temporary profiles to drive the system off of the data the user is entering. “Friends” can be linked together in all four profiles independently.

The individual profiles (503) contain information such as detailed preferences, friend information, location information, contact information, link to personal calendar, etc. The coordinator profiles (502) contain the same information but also include interfaces to personal contact information and saves more data that is entered. These profiles are for professional travel agents, group trip planners, or administrative assistants within corporate America. The trip profiles (504) contain information/preferences specific to a trip and defines the group as a collection of all individual profiles or manual information entered and stored in the trip profile. This trip profile is then used in the search/optimization algorithms and is used to coordinate the travel with all members in the booking/coordinating engine. The profile is stored (505) for easy trip planning of similar events in the future. In addition, the Pre-Trip profiles (501) can be sent to group members prior to researching/planning the trip to add their individual preferences, dates of availability, and budgets for example prior to spending time working on the trip. The pre-trip profile will be gathered and consolidated into the normal trip profile.

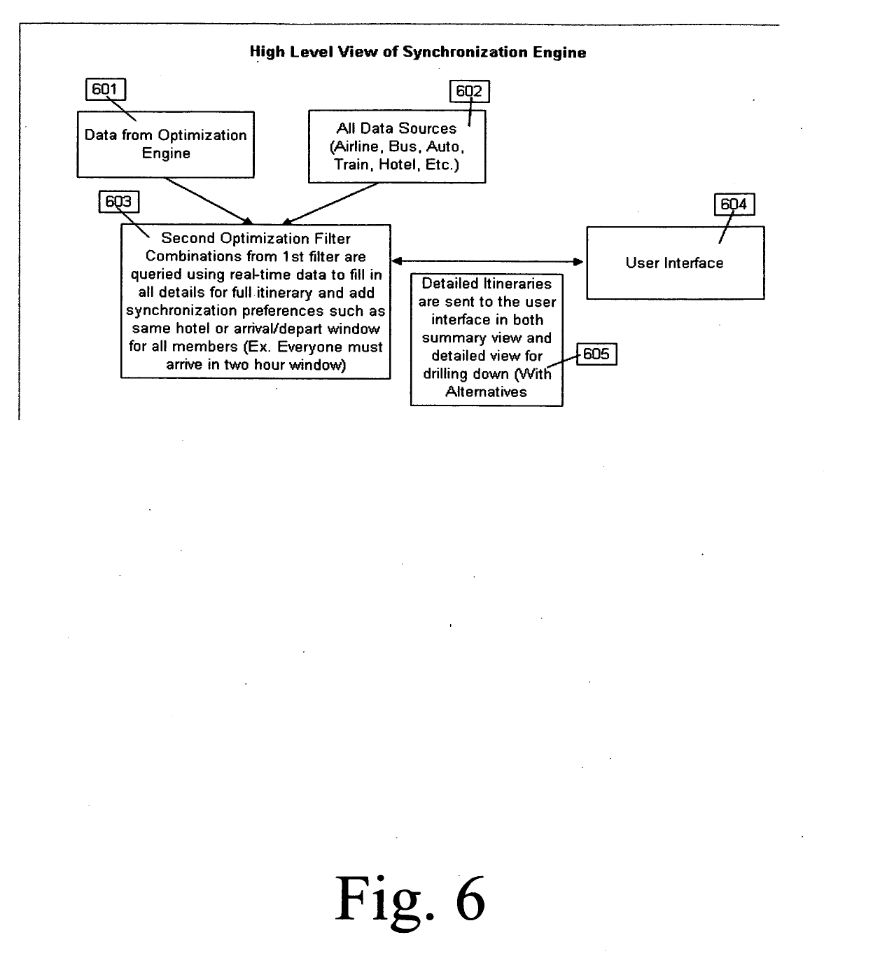

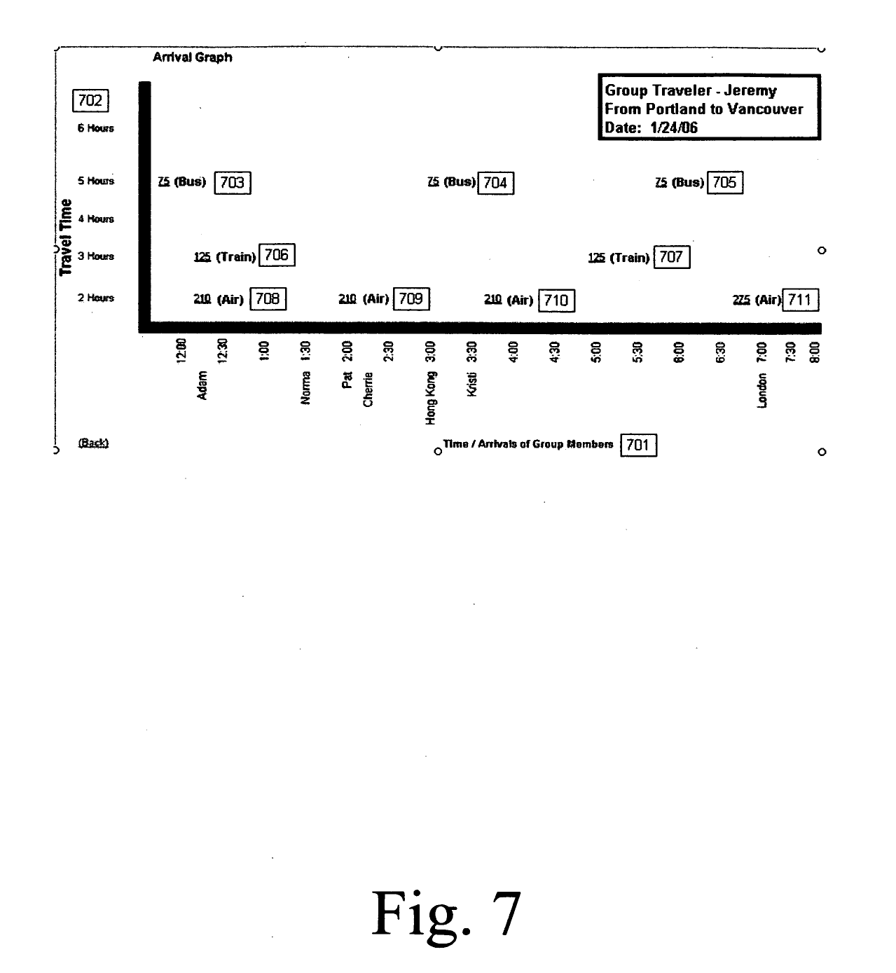

The synchronization engine of the present invention is illustrated in FIG. 6. This synchronization engine's (603) primary purpose is to optimize and synchronize at a detailed level for Individual itineraries with the group itinerary and preferences as a constraint. The engine receives its reference data (601) from the optimization engine and adds the detailed travel information (602) to each individual itinerary (605) in an iterative process that is constrained by the trip profile and synchronization preferences. If an itinerary cannot be developed under the constraints, alternatives are formed as close to the constraints as possible based on trip preferences/default tradeoffs such as Time vs. Cost and passed along with the group itinerary to the user interface (604). The resulting group itineraries are sent to the user interface with both a summarized view of the data along with individual itinerary details.

One output of the synchronization and multi-mode travel component is illustrated in FIG. 7. When a user drills into their itinerary to make changes, they can use this tool to synchronize their travel plans with the arrivals and departures of others (701). They may also optimize the mode or plan multimode travel using this tool while synchronizing schedules. The hours of travel (702) are located on the Y access of the chart. Each data point (703-711) on the chart represents a travel option and it's cost and may be drilled into to view additional details. Travel options (703-705) represent bus travel and show the associated duration of travel in hours and the arrival time relative to other members of your group. Train travel (706-707) and Air travel (708-711) are also exhibited on the graph. An additional component not illustrated in this particular example is the multi-mode travel which would be it's own data point in this graph but upon drilling into the item would see the details of travel such as air followed by bus travel.

It is appreciated that that while the invention has been described in conjunction with the detailed description thereof; the foregoing description is intended to illustrate and not limit the scope of the invention. Other aspects, advantages, and modifications are within the scope of the following claims. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A software tool that is used to research, plan, optimize, synchronize, coordinate, hold reservations, book, pay, and confirm travel arrangements for multiple people from multiple geographic locations to a single location or series of locations comprising;
internal system and database components comprising:
a research, simulation and planning engine;
a time component as means to enable True Time of Travel;
summarization tables;
routing tables;
optimization engines for each different level of detail including:
queries of industry data in real-Time, static summarization tables, internal data, and linear programming for the following queries:
destination;
date selection;
mode and route of transportation;
lodging;
other coordinator, trip, group, or individual preferences; and
Combinations of multiple criteria
synchronization optimization engines;
coordinator, individual, linking, trip and pre-trip profiles;
reservation mechanism;
costing and payment coordination engine;
coordination engine;
confirmation component;
negotiation component;
trip management component;
booking mechanism;
a back end consisting of:
a connection to industry data sources;
a connection with industry reservation services;
a connection with payment services; and
communication means for communicating with user via Email, Instant Message, phone, or pager; and
a front end consisting of:
a stand alone web based interface; and
integration into other mediums or legacy systems.

2. A primary interface for the travel and trip planning web based software tool interface and set of processes that are focused on travel research, reservation, and booking for multiple people from multiple locations to a common destination or series of common destinations wherein;
from said interface, a user navigates through the software tool's components, researches, simulates, and plans the group trip;
individual, coordinator and trip, and pre-trip profiles are set up;
data entered said interface drives most internal engines including travel optimization, synchronization, and coordination engines;
the type of data entered and fed into the engines includes in any combination individual parameters, dates, mode of transportation, member locations, destination, specific dates, consider all members, group and trip preferences, and cost group trip;
a module then performs a search to find a group itinerary consisting of individual itineraries for each group member from the same or different geographic regions, in one system and in one query, as individual trips are planned in today's models.

3. The process of claim 2 further comprising a process component for entering trip parameters resulting in group trip itineraries returned in a summarized view with the ability to drill down into the itinerary details consisting of the following primary process steps:
(a) a user opens up the web interface;
(b) said user logs into system if they have already set up coordinator, individual, or trip profiles;
(c) said user sets up coordinator, individual (Personal), pre-trip or trip profiles;
(d) said user enters each trip members' information;

4. The process of claim 3 wherein said user enter user names and said user names will link profile information that contains individual preferences.

5. The process of claim 3 wherein:
said user enter full names and said full name or profile name will be required later to reserve or book travel;
and a minimum requirement of entering the location of trip members must be entered.

6. The process of claim 3 wherein contact information is if coordination engine is used such that a user must:
enter travel destinations or allow the system to optimize the destination based on trip optimization preferences; and
enter specific dates of travel, vague dates of travel or vague dates of travel to maximize days of trip based on a cost willing to spend parameter, or combination thereof.

7. The process of claim 3 wherein contact information is if coordination engine is used such that a user must enter travel and optimization preferences contained in a trip profile or pre-trip profile so that default values are established so that the user may ignore these steps or adjust these parameters;

8. The process of claim 3 further comprising a trip optimization preference where the user must select how the search and optimization engine will narrow the results: the user can select optimization preferences based on shortest total travel time, maximize total group time at location, cheapest total trip costs, fit into budget constraints, maximize group preferences, dates, availability, location, and transportation modes.

9. The process of claim 3 further comprising trip synchronization preferences which can be made at the high level of detail and at the low level of detail.

10. The process of claim 3 further comprising a individual trip member preferences enabling a user to drill down into preferences within a matrix consisting of trip members in rows and preference options in columns;
default values are determined based on the trip profile, pre-trip profile or linked individual profiles;
a coordinator may change any preferences; and
individual preferences include: activities desired, value of time, mode of transportation, availability, willingness to pay, or amount of time willing to commit.

11. The process of claim 3 wherein:
a user may save information entered as a trip profile or pre-trip profile;
pre-trip profiles are established and sent to group members to solicit feedback prior to planning group trip;
said user then triggers the search engine;
if trip profile is not established, one will be saved so that all information is saved together and passed to the different system components as one packet of information;
resulting group itineraries are returned in a summarized form; and
individual details can be viewed by drilling into a summarized view.

12. The process of claim 11 wherein a user may reiterate the process, change preference items and perform a new search to create new group itineraries.

13. The process of claim 12 further comprising wherein a user may change individual itineraries at the detailed level, independent from group itinerary and said changes are rolled up to the group summary level.

14. The process of claim 3 further comprising wherein when a user selects the group itinerary the system moves out of the research, simulation, planning, and trip selection module and the user is be directed to the reservation, booking, and coordination engines.

15. The software tool of claim 1 which is a web-based interface that is linked to the bulk of the core system components and indirectly to data sources and communication software tools which creates a framework to guide a user experience and process for research, planning, coordinating, and booking group travel by entering date in the interface and storing it in database tables combining in combination:
a time component that creates the ability to build non-traditional time components into travel optimization and selection, giving the user the ability to build in their cost of time to make the tradeoff between different travel options;
a table of summarization is used to create summarized data at a high level of detail that can be queried quickly to optimize complex many-to-many optimization problems; routing tables for filtering the data coming into said summarization table.
an optimization engine for determining high-level optimized group itineraries based on user input, producing itineraries at a high level of detail, which are passed to a synchronization engine to optimize at a finer level of detail; and
synchronization optimization engines which reefing the group itineraries passed to it from the high-level optimization engine and adds current detailed information from industry data sources, creating actual detailed individual itineraries based on group and individual synchronization preferences which are modified in an iterative process based upon trip or individual profiles.

16. The software tool of claim 15 wherein group trips are weighed according to trip preferences and the top group itineraries are passed to the user in summary and detailed format while alternatives at the individual lever per group itinerary are passed along to the user interface.

17. The software tool of claim 15 further comprising an optimization algorithm that creates a filter of the data based on the trip preferences and based on this subset of data, an iterative process is used based on optimization preferences to evaluate alternatives and arrive at the top recommendations for destination.

18. The software tool of claim 15 further comprising an optimization algorithm which creates a filter of the data based on the trip preferences that is used independently of destination optimization or in tandem so that the subset of data can be viewed in an iterative process that is used based on optimization preferences.

19. The software tool of claim 18 wherein if a calendar program is used by group members, a summarization of all individual availability can be tied to the triptravel profile for use in optimization of the group trip based on schedule availability along with the other criteria and preferences.

20. The software tool of claim 15 further comprising optimization of mode and route of transportation at the individual itinerary level wherein optimization algorithms are performed after the destination and time components have been chosen and a filter of the data is created based on the individual or trip preferences which is then used in an iterative process based on optimization preferences to evaluate alternatives and arrive at the top recommendations for time in the summarization table.

21. The software tool of claim 15 wherein there are five costing points captured in the summarization table for the optimization engine to pull from based on the trip parameters, including:
cheapest price;
shortest time traveled;
midpoint;
the point at which incremental time savings becomes small relative to cost increase; and
the point at which cost savings are marginal relative to the increase in travel time.

22. The software tool of claim 21 wherein the software tool enables a user to pick optimized routes that include multi-mode travel.

23. The software tool of claim 15 further comprising:
a coordinator profile which is a more detailed profile for a user who plans trips on a more frequent basis;
a trip profile which contains all of the trip preferences; a pre-trip profile is established prior to planning a trip and sent out to the group members to solicit feedback preference in regards to the particular trip;
a reservation mechanism used to hold a reservation for the group until a group hurdle has been reached and the trip moves into the booking engine;
a costing and payment coordination engines which allows the group to spread the four types of costs:
travel arrangements;
trip adders;
service fees;
coordinator fees;
either by:
everyone paying an equal share of total group trip cost;
ability to pay;
comping;
each paying for their individual costs;
everyone paying an equal share based on cheapest transportation to location and shared costs; and
donations;
a coordination engine used to coordinate the trip with all members once the trip profile and itinerary has initially been selected and the reservation has been made comprised of three primary components:
an auto confirmation software tool and process;
a trip negotiation software tool and process; and
a trip management component;
an auto confirmation software tool that seeks confirmation of the trip with each group member via to confirm reservation, Make changes personal reservation, Wait, Set personal Conditions, Decline, or Propose an Alternative Group Itinerary;
a trip management component which creates a medium for:
trip details to be displayed to all members
communication to all group members;
trip status information;
uploading of files; and
archiving old trips that can be recreated with ease in the future; and
a booking mechanism for converting group and individual reservations into actual bookings.

24. The software tool of claim 23 wherein once the booking hurdle has been reached, the reservation of those members who have confirmed the trip will be converted into a ticket and payment will be taken from previously entered payment information.
